(19) United States
(12) Patent Application Publication
(10) Pub. No.: US 2022/0001374 A1
(43) Pub. Date: Jan. 6, 2022

(54) Containment Hybrid Partitioned Casework

(71) Applicant: Reza Agahian, Ridgefield, CT (US)

(72) Inventor: Reza Agahian, Ridgefield, CT (US)

(21) Appl. No.: 17/389,065

(22) Filed: Jul. 29, 2021

Related U.S. Application Data
(63) Continuation-in-part of application No. 16/946,038, filed on Jun. 3, 2020, now abandoned.

(51) Int. Cl. B01L 1/02; F24F 7/00; B01L 1/04

(52) U.S. Cl. CPC B01L 1/025; B01L 1/04; F24F 7/00

(57) ABSTRACT

A hybrid partitionable casework system is provided. The system includes a base wall supported by vertical structural components and horizontal structural components attached to the vertical structural components. The vertical structural components are interlockable with a self-supportive partition panel. A method of partitioning a laboratory space from an open bench type layout to biosafety level 3 to a clean room configuration. At least two hybrid partitionable base walls having support elements are attached to at least one self-supportive partition panel.

This application is a continuation in part of U.S. application Ser. No. 16/946,038, filed Jun. 3, 2020 and claims priority benefit thereof. Application Ser. No. 16/946,038 is entirely incorporated by reference herein.

### BACKGROUND OF THE INVENTION

The present invention relates to partitionable casework and, more particularly, to hybrid partitionable casework for laboratory containment.

Currently, laboratory casework systems either have an adaptable and open arrangement or comprise of built-in cabinetry. In either case, when it becomes necessary to partition a portion of the lab due to cross contamination or other reasons, contractors are usually required on-site to install walls to close and contain the area or allocated space. Existing devices require the construction of new walls and the installation of utilities for partitioning laboratory spaces. They do not lend themselves to the easy, rapid partition of a space without major construction.

Highly infectious viruses have appeared in the past decade, with the latest being the novel coronavirus that causes COVID-19. These viruses have a devastating impact on our societies. Laboratory space that may normally be an open and adaptable workspace may need to be retrofitted on short notice to provide laboratory staff an isolated laboratory space to accommodate working with the infectious materials. Therefore, there is a need for a laboratory casework system that provides rapid partitioning without particularly skilled construction crews.

The present invention provides a containment hybrid partitioned casework system or a Hybrid Containment Module (HCM) system that may be partitioned with ease within a very short time, turning an open laboratory layout into partitioned rooms. The cabinetry may be adaptable in an open arrangement, yet a laboratory space may be isolated overnight by inserting prefabricated panels or other material into the inventive base wall or wall system that together with structural members, enclosure or closure panels, and laboratory cabinets encompasses a flexible laboratory casework wall system where all the utilities are independent from the structural members. The hybrid partitionable casework may be partitioned without any major construction and without disrupting laboratory operations. Previous laboratory casework systems with core structural support may or may not be connected to the building structural elements in the ceiling. However, some of the previously described flexible design systems, such as U.S. Pat. No. 5,212,915 (the '915 patent) or U.S. Pat. No. 6,115,978 (the '978 patent) run the required utilities within the structural core of their systems. This is an important disadvantage in providing a rapid flexible transformative system. Such systems cannot easily and rapidly transform from an open laboratory design to a biosafety level 3 system or providing a clean room configuration.

The present invention may be easily utilized to convert from a typical biosafety level 2 laboratory to a fully contained clean room and/or a biosafety level 3 (BSL-3) and BSL-3 enhanced laboratory where research on viruses such as COVID-19 can safely be conducted.

### SUMMARY OF THE INVENTION

In one aspect of the present invention, a hybrid partitionable casework system is provided comprising a base wall or wall system (FIG. 17) supported by vertical structural components and horizontal structural components attached thereto, wherein said vertical structural components are configured to interlock with a self-supportive partition panel.

In another aspect of the present invention, a method of partitioning a laboratory space is provided, comprising providing at least two hybrid partitionable wall systems having support elements that provide at least one self-supportive partition panel and attaching the at least one self-supportive partition panel to said support elements on the at least two hybrid partitionable wall systems.

These and other features, aspects and advantages of the present invention will become better understood with reference to the following drawings, description and claims.

In the Hybrid Containment Module (HCM) of the present invention all casework supported utilities run outside the core structural elements, making the system extremely flexible to transform the space from an open laboratory to an enclosed laboratory space where specific bio manufacturing practices as conducted in clean room environment, tissue culture work, instrumentation related experiments, or microscopic research may be conducted. In addition, this invention allows for an easy removal of partitions to allow for the casework to return to its original state of open lab environment. This is an important difference between the HCM invention and other previously described systems, such as U.S. Pat. No. 4,667,579 (the '579 patent) where a modular clean room is built within a building and cannot be easily transform to an open type of structure.

### BRIEF DESCRIPTION OF THE DRAWINGS

FIG. 1 is a perspective view of hybrid partitionable base wall or wall system according to an embodiment of the invention;

FIG. 2 is another perspective view thereof, with shelves installed, and casework positioned for use;

FIG. 3 is a perspective view illustrating the base wall of FIG. 2 with partitions installed;

FIG. 4 is a sectional view of the base wall of FIG. 2 taken at line 4-4, with attachments and environmental structure shown in phantom;

FIG. 5 is a sectional view of the base wall of FIG. 2 taken at line 5-5, with attachments and environmental structure shown in phantom;

FIG. 6 is a perspective view illustrating the fully partitioned lab including the autoclave;

FIG. 7 is an elevation of the partitioned lab modules with autoclave;

FIG. 8 illustrates HCM Open Type and BSL-3 where through the HCM partitioned system an open lab can completely convert into a Biosafety Level 3 laboratory;

FIG. 9 illustrates the conversion of an open laboratory setup to a fully enclosed clean room area with lockers and pressure regulated vestibules;

FIG. 10 illustrates the locking mechanism for the insulated composite panels sealing the lab partitions attached to the vertical steel structural members;

FIG. 11 illustrates isometric view of the base plate installation to seal the partitioned portion of the lab;

FIG. 12 illustrates elevation view of the base plate installation to seal the partitioned portion of the lab;

FIG. 13 illustrates the sectional detail of a sealed light fixture in insulated composite ceiling component;

FIG. 14 illustrates the perspective view of the Biosafety Level 3 Laboratory;

FIG. 15 illustrates the incorporation of fume hoods and biosafety cabinets in the lab modular support system;

FIG. 16 illustrates the enclosure of the lab module by incorporating built-in equipment such as fume hood or Biosafety cabinet Class III; and

FIG. 17 illustrates the sectional view of the bench of FIG. 15 taken at 17-17, with attachments and infrastructure shown outside the structural core of the support elements.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, directional terms such as upper, lower, upward, downwardly, top, left, right and the like are used in relation to the illustrative embodiments as they are depicted in the figures, such that the upward direction (or upper) being toward the top of the corresponding figures and the downward direction being toward the bottom of the corresponding figures.

“Containment” as used herein refers to installation of partitions to contain a laboratory area and may include modifications to the mechanical infrastructure to provide negative airflow to the partitioned space for full isolation. The term is used interchangeably herein to describe casework that may be modified by partition panels to form a contained laboratory area.

The term “hybrid” refers herein to the adaptability of the present invention to multiple partition panel materials and containment requirements.

As used herein, the term “casework” refers to some combination of freestanding tables with cabinetry, lower cabinets, upper cabinets with shelves, and/or a base wall or wall system with upper cabinets.

As such, a “partitioned casework” refers to casework comprising some combination of a base wall or wall system and shelves or upper cabinets transformed into a partition by the addition of partition panels. The term “partitioned casework” is used interchangeably to also include casework that is partitionable.

The term “adaptable” describes a workspace that may be quickly and easily modified by adding or removing modular components.

The term “support elements” includes but is not limited to predrilled slots, grooves, brackets, and add-on frame connectors.

A “quick disconnect coupling” refers to a utility umbilical connector that allows quick and easy relocation or detachment and reattachment of all utilities present when adding partitions to a lab space.

The term “clean room” is defined herein as a controlled environment that has a low level of pollutants such as dust, airborne microbes, aerosol particles, and chemical vapors.

The term “Biosafety Level” laboratory is defined and described by the Center for Disease Control (CDC). The CDC has outlined four biosafety levels based on their risk of impact on human health. CDC's detailed outline for various biological risk groups and biosafety levels can be found in Biological Safety: Principles and Practices, Fifth edition.

The CDC define risk group one as agents that are not associated with disease in healthy humans. The risk group one only requires a biosafety level one (BSL-1) facility that incorporates a basic level of containment that relies on standard microbiological practices with no special primary or secondary barriers recommended, other than a sink for hand washing. The BSL-1 one work is done with defined and characterized strains of the viable microorganisms not known to cause disease consistently in healthy adult humans. For example, Bacillus subtilis, Nigeria gruberi, infectious canine hepatitis virus, and exempt organisms under the NIH Guidelines are representative of microorganisms meeting these criteria.

Risk group two contains agents associated with human disease that is rarely serious and for which preventive or therapeutic interventions are often available. Research for risk group two agents is conducted in BSL-2 facilities where secondary barriers such as hand washing sinks and waste decontamination must be available to reduce potential environmental contamination. For example, Hepatitis B virus, HIV, the Salmonella, and Toxoplasma are representative of microorganisms assigned to this biosafety level.

Risk group three contains agents associated with serious or lethal human disease for which preventive or therapeutic interventions may be available (high individual risk but low community risk). Work with risk group three agents must be conducted in BSL-3 laboratories. BSL-3 practices, safety equipment, and facility design and construction are applicable to clinical, diagnostic, teaching, research, or production facilities in which work is done with indigenous or exotic agents with a potential for respiratory transmission, and which may cause serious and potentially lethal infection. For example, Mycobacterium tuberculosis, St. Louis encephalitis virus, and Coxiella burnetii are representative of microorganisms assigned to this level. Primary hazards to personnel working with these agents relate to autoinoculation, ingestion, and exposure to infectious aerosols. At BSL-3, more emphasis is placed on primary and secondary barriers to protect personnel in contiguous areas, the community, and the environment from exposure to potentially infectious aerosols. For example, all laboratory manipulations should be performed in a Biosafety Cabinet or other enclosed equipment, such as a gas-tight aerosol generation chamber. Secondary barriers for this level include controlled access to the laboratory and ventilation requirements that minimize the release of infectious aerosols from the laboratory.

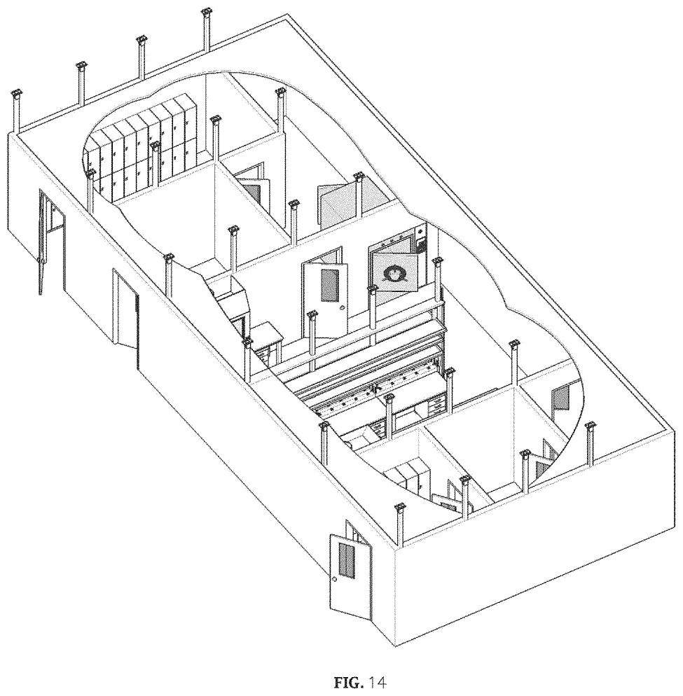

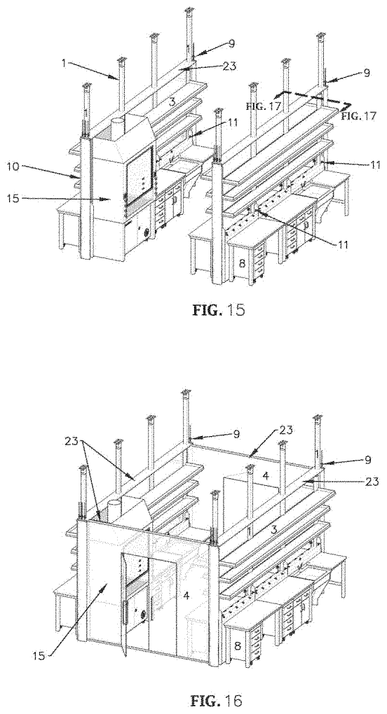

Agents classified as risk group 4 are likely to cause serious or lethal human disease for which preventive or therapeutic interventions are not usually available (high individual risk, and high community risk). BSL-4 practices, safety equipment, and facility design and construction are applicable for work with dangerous and exotic agents that pose a high individual risk of life-threatening disease, which may be transmitted via the aerosol rout and for which there is no available vaccine or therapy. Agents with a close or identical antigenic relationship to BSL-4 agents also should be handled at this level. When sufficient data are obtained, work with these agents may continue at this level or at a lower level. Viruses such as Marburg or Congo-Crimean hemorrhagic fever are manipulated at BSL-4. The primary hazards to personnel working with BSL-4 agents are respiratory exposure to infectious aerosols, mucous membrane or broken skin exposure to infectious droplets, and autoinoculation. All manipulations of potentially infectious diagnostic materials, isolates and naturally or experimentally infected animals, pose a high risk of exposure and infection to laboratory personnel, the community and the environment. The laboratory worker's complete isolation from aerosolized infectious materials is accomplished primarily by working in a Class III Bio Safety Cabinet (FIG. 15, 16, item 15) or full-body air-supplied positive-pressure personnel suit. The BSL-4 facility is generally a separate building or completely isolated zone with complex, specialized ventilation requirements and waste management systems to prevent release of viable agents to the environment.

Broadly, one embodiment of the present invention is a hybrid partitionable casework system comprising a base wall or wall system FIG. 17 with a plurality of vertical structural elements 1 configured to support a plurality of shelves 3 and/or partitions 4 and horizontal structural members items 14, and 18. A plurality of self-supportive prefabricated partitions 4 may be used with the inventive system, enabling conventional top horizontal metal beams to be eliminated. Additionally, much lighter materials may be used when prefabricated partitions are installed. The inventive partitionable wall system comprises support elements operative to structurally carry shelves, reinforce a lower core portion of the wall, and, when containment and/or isolation is desired, support modular, prefabricated wall sections.

The space between the vertical and horizontal structural members and the enclosure or closure panels 2 in the base provide housing for various utilities FIG. 17 item 7, such as electrical conduits, data wires, and plumbing components including pipes, and valves. The utilities do not run through the structural system of the base wall or wall system item 1 an important distinguishing characteristic of the invention that allows for the easy and relatively quick transformations from the open type of laboratory system to the BSL-3 and/or clean room type of system.

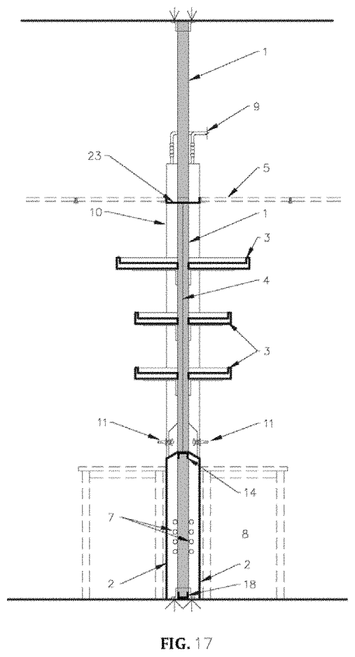

The core of the system houses all the utilities, which are routed to the top of the wall system and shown in the FIGS. 15, 16 item 9. The utilities run along and within the closure panels 2 and emerge as shown 9 at the top of the vertical umbilical cord 10. This arrangement allows for the different layouts a laboratory, such as a vestibule for entrance and exit to a bay. This configuration may also accommodate the physical boundary necessary for clean rooms or secure lab space with higher biosafety containment requirements.

A generally U-shaped panel FIG. 17 item 2 may run between the vertical structural members 1 and fill a gap behind the shelves. The panel may be folded, for example to about ½ or about ⅓ of its full depth to allow installation of a partition between the vertical supports.

The shelves may be detachably installed to the vertical structural members, which may have a span of about 2 to about 6 feet, such as about 4 feet, therebetween. Due to the long span, the shelves may be further supported by a support plate running the full length of the shelves, integral with the brackets by which each shelf is installed. The plate may be angled at each end of a shelf and may have attachment members, such as hooks, insertable into predrilled slots on the vertical structural members. The material of construction of the plate is not particularly limited and may for example, be a metal, such as steel or any other structurally sufficient material.

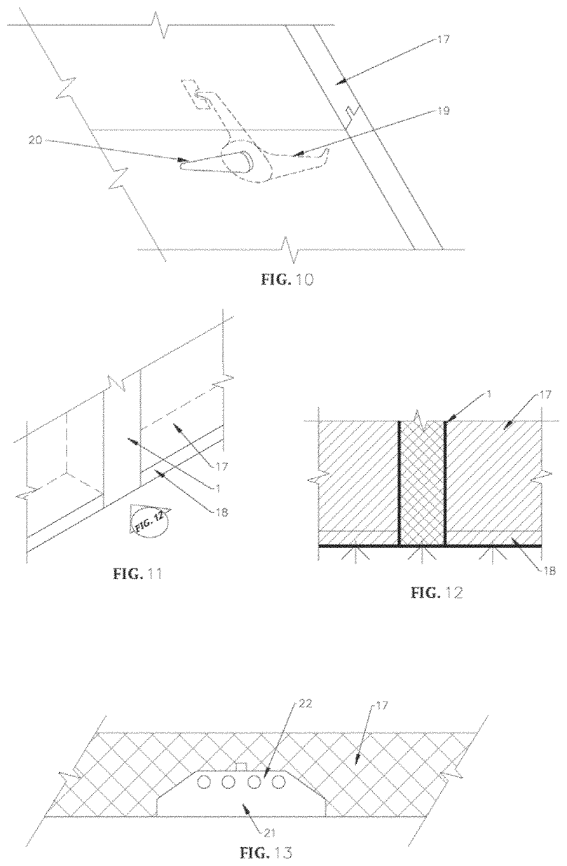

A person may remove shelves by detaching supporting brackets and may install prefabricated wall sections. All existing utilities may be strategically located away from the areas where changes are likely to occur. The location may be predetermined as a characteristic of the base wall or system wall or the utilities may be easily movable to another location in or on the base wall. Once the prefabricated wall sections (FIG. 17, item 4, FIG. 10, 11, 12 item 17) are installed, the shelves may be reinstalled and the utilities may be reattached. Fully sealed and secured to the floor item FIG. 11, 12, 17, item 18 acts as a base and anchor plate for the prefabricated wall sections.

The materials used to manufacture the inventive partitionable wall system (item No. 17) are not particularly limited. The base wall 10 may have metal or other finishes. Partitions 4 may be manufactured from a material selected from, but not limited to, tempered glass, fire rated glass, factory assembled insulated fire rated walls, and clean room partitions. In case of fire rated partitions, the base wall or system wall may be extended to the top structure of the space where the unit is built. Composite faced insulated wall panels can be installed above the ceiling in the case of clean rooms. In Biosafety Level 3 facilities insulated airtight ceiling panels composed of insulation filled composite surfaces with airtight LED light fixtures (FIG. 13, item 17, 21, 22) span between the transverse horizontal structural members.

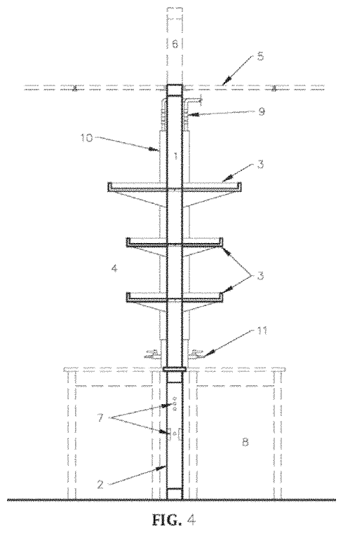

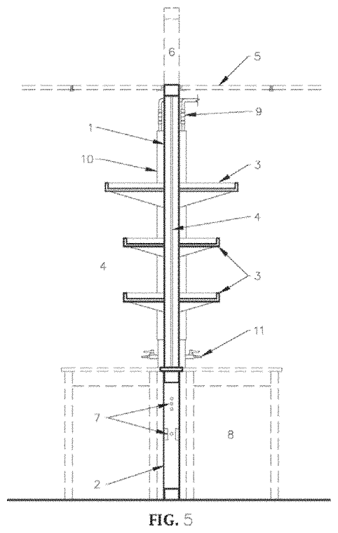

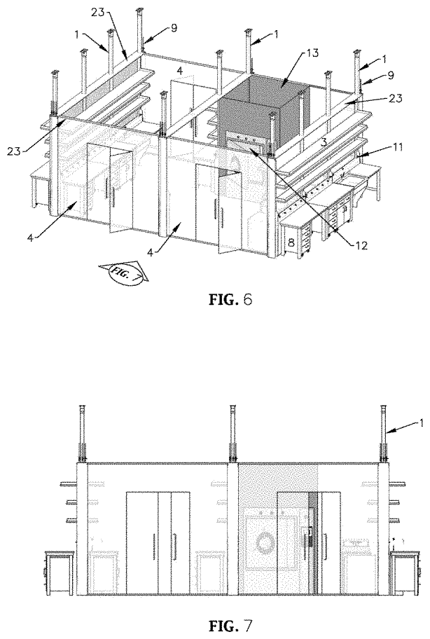

Referring to FIGS. 1 to 5, FIG. 1 illustrates two parallel wall system (i.e., the core of the containment hybrid partitioned casework) comprising vertical 1, 6 and horizontal structural members 23, 14, 18 (see also FIG. 17). The closure panels 2 in FIG. 17 are tightly secured and sealed together and provide airtight environment when attached to the member 1 as illustrated in FIG. 17. These closure panels 2 allow the utility pipes 7 and conduits to run outside the structural core of the Hybrid Containment Module. Predrilled slots, grooves, and add-on frame connectors (not shown) may be provided to accommodate installation of generic prefabricated wall-panels as illustrated in FIGS. 10, 11, 12, and 13. Strategically located screws connect the structural members 1 to the umbilical attachment 10 for utilities such as air, vacuum, water, power and data. The utilities may run to freestanding adjacent tables or may be distributed horizontally at the base FIG. 4 item 2.

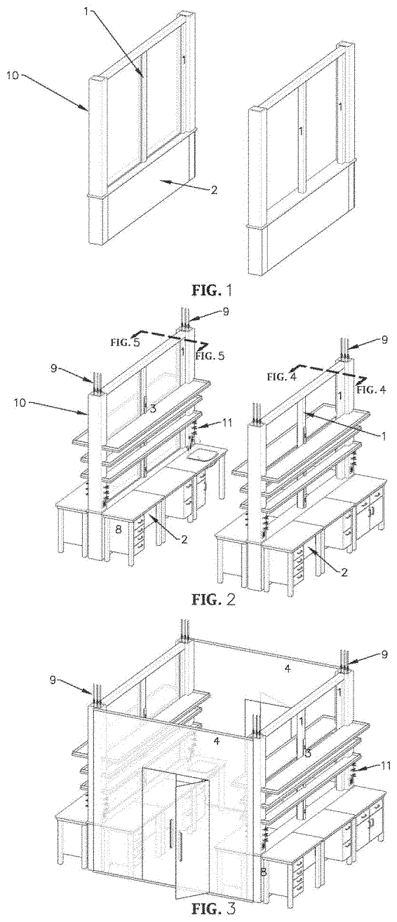

FIG. 2 illustrates the completion of FIG. 1 with plurality of shelves 3 and freestanding tables with cabinetry 8 positioned adjacent each closure panels 2. FIG. 3 illustrates a partitioned laboratory space with vertical structural tubes 1 supporting partitions 4 and a quick disconnect coupling 9. A plurality of Vertical and horizontal structural members 1, 23, 14, and 18 support shelves 3, for example, by way of brackets, and glass partitions 4 or composite partitions as illustrated in FIGS. 10, 11, 12, and 13. The wall system may house utilities 7, including power, data, and gas, for example, see FIG. 17. One or more tables with cabinetry 8 may be installed onto the wall system with closure panels 2 that are sealed to the floor and secured to the horizontal structural member 14. The structural members 1 extend beyond the suspended ceiling 5, if present, and are additionally supported with a vertical structural member 6 located at the ceiling level and additional horizontal members 14, 18. FIG. 2 shows two isometric images of the module without glass. FIG. 3 shows the partitions with glass enclosures 4.

FIGS. 4 and 5 each provide a sectional view of an inventive wall system (Components shown in FIG. 1) with enclosure panels 2 of FIG. 17 with shelves installed. Casework (i.e., tables with cabinetry), a suspended ceiling, 5 are depicted in dashed lines. Easily accessible ports for gas, water or vacuum are also shown 11.

The invention may be used as follows. The core of the base wall or wall system may be provided with built-in power, data, gas lines and water lines 7 connectable to a quick disconnect coupling (FIG. 17 item 9) in a laboratory. Tables with cabinets 8 and/or shelves 3 may be installed or removed as necessary. Prefabricated partitions composed of interlocking insulated composite wall and ceiling systems FIG. 10,11,12,13, item 17 may be added to the system to close an area off from the rest of the laboratory.

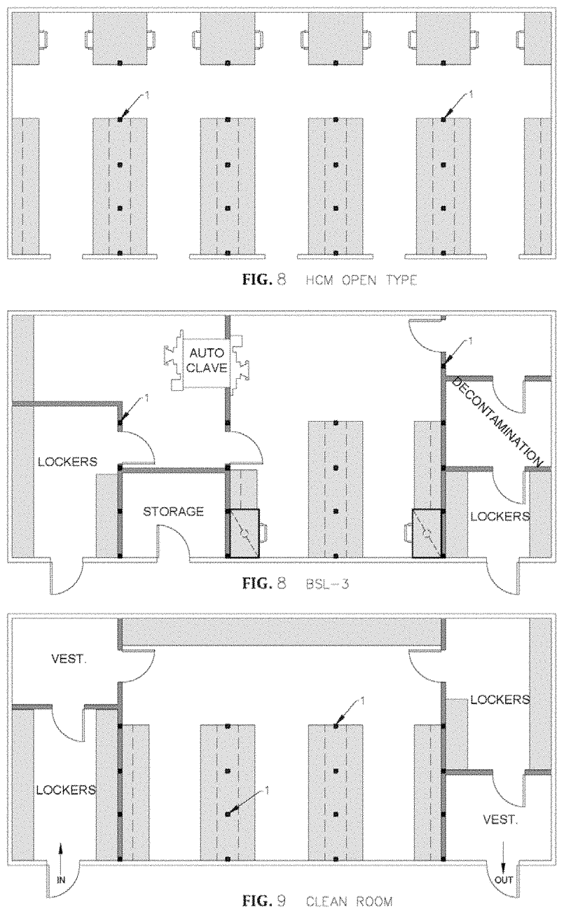

In contrast to the '915 patent, the present Hybrid Containment Module (HCM) invention, has all its utilities running outside the structural core of the casework. Although the '915 patent describes the incorporation of workspaces, utilities and storage cabinets, the present invention is substantially different. The present invention, with its HCM system, is designed and configured to accommodate various activities that require environmental barriers that are not described or claimed in the '915 patent. In the present invention the enclosure or closure panels FIGS. 10, 11, 12, 13 item 17 surfaces are constructed of composite chemically resistant materials and separated by solid insulation (for example, polyurethane insulation core (PUR)). The panels 17 approximately 3′×6′ stacked horizontally (FIG. 10) and interlocked by special screw type of mechanism from the outside (items 19 and 20 in FIG. 10) tightening the interlocking mechanism (FIG. 10 item 19) and sealed (FIGS. 11 and 12) specifically to allow for the total control of the environment within the confined space and to achieve a functionally clean space. In BSL-3 or level 3 enhanced laboratories the present invention provides a completely sealed environment and is conducive in performing research on viruses, such as Covid-19. The closure panel (FIG. 17, item 2) and HCM structural members supports (FIG. 4 items 1, 6, 14) can remain in their original locations as their placement is based on the laboratory planning module system (FIGS. 1, 2, and FIG. 8 HCM open type). FIG. 8, HCM Open Type refers to an open type of laboratory system that can be transformed to an environmental closed system. The conversion of the regular open laboratory configuration, FIG. 8, HCM Open Type, to a fully contained environmental space can be achieved by inserting the insulated composite walls and ceiling panels between HCM's structural members (FIG. 14). The insulated composite panels are secured together from the exterior by rotating the concealed hooks by special tools (FIG. 10 items 19, 20).

All the base elements of the original island type of bench layout (FIG. 8, HCM Open Type) constitutes a typical HCM open lab island casework and has all the necessary elements to transform it to environmentally controlled isolated rooms, FIG. 9, that can house a positive pressure room. This type of layout is not similar to the clean room enclosures of US Pub No. 2019/0017714 A1 (the '714 Pub) or US Pub. No. 2019/0208613 A1, (the '613 Pub). The HCM has many uniquely distinguishing capabilities. Some of the properties of the HCM is its capabilities to be transformed from an open bench type layout, to a BSL-3, or a clean room and then can be easily reversed into any of the three types of configurations. This type of invented arrangement is not described or claimed in the prior art.

Insulated self-supporting wall panels, cold rooms, clean room modules with self-sufficient mechanical components described in the literature are very different from the HCM. The HCM can be transformed from a basic lab bench to a fully insulated environmental controlled space and then have the capability to turn back again to a basic lab bench type of configuration. The cost and schedule of these complex structures are reduced substantially since the base material in the island bench type system supports the complex built-up of the environmentally controlled space.

Dedicated supply and exhaust fans can be installed on the roof of the HCM or in an adjacent space to provide the required HVAC for the clean room. The quick disconnect coupling is used to maintain the same versatile access to gases when the room transforms into a clean room from a basic lab island type of configuration. The casework infrastructure and in this case the quick disconnect 9, FIG. 17 is built to intertwine with the future clean room or bio safety level 3, or biosafety level 3 enhanced space. This arrangement takes into consideration various types of materials that comprise the sealed enclosure or closure panel, FIG. 17, (item no 2) that will support concealing the utilities such as gas, water, power and data FIG. 17 (items 7, 11).

HCM's structural elements serves multiple purposes: a) Spanning from floor to structure above, and being anchored securely at both ends (FIG. 1, item 1) provides a strong solid support for any lateral force that may be at play; b) Glass partitions (FIG. 3), insulated metal panels (FIG. 11, 12, 13), and fire-rated panels are sealed up against these elements; c) Laboratory related equipment that are built-in and linked to building infrastructure such as fume hoods, autoclaves, etc (FIG. 5, 6, 7, 15, 16) are tied into these structural elements; and d) Movable lab equipment such as refrigerators, freezers, freestanding and benchtop equipment such as mass specs can be tied to the structurally stable HCM elements.

Moreover, all loose tables and cabinets can be secured to the core of the island bench configuration securing lateral stability for all casework.

The HCM system differs from all other systems by being reversable to its original island shape. In previously described or claimed systems, reversibility might transform the apparatus to an empty room and not to another type of viable laboratory configuration. The HCM basic island bench component configuration can be transformed to a fully enclosed laboratory environment such as a BSL-3 suite (FIG. 8-BSL-3) or a clean room (FIG. 9), and at any given time the partitions can be removed and the area can take its original shape of an island bench type configuration, FIGS. 1, 2, and 15.

It should be understood, of course, that the foregoing relates to exemplary embodiments of the invention and that modifications may be made without departing from the spirit and scope of the invention as set forth in the following claims.

What is claimed:

1. A hybrid containment module comprising:
an adaptable configuration of a system wall supported by a plurality of vertical structural components, a plurality of horizontal structural components attached thereto, wherein said plurality of vertical structural components and plurality of horizontal structural components are configured to interlock with a plurality of self-supportive partition panels, enclosure panels and biosafety cabinets providing for a certain biosafety containment structure.

2. The hybrid containment module of claim 1 wherein the system wall contains repositionable utility lines connectable to a quick disconnect coupling to provide for the configurational changes from an open type bench layout, a biosafety level 3 and a clean room type of said hybrid containment module.

3. The hybrid containment module of claim 1, further comprising a fume hood to provide for laboratory containment and isolation.

4. The hybrid containment module of claim 1, further comprising an autoclave to provide for a biosafety containment and isolation.

5. The hybrid containment module of claim 1, further comprising a vertical structural extension to provide for laboratory containment.

6. The hybrid containment module of claim 1, further comprising a plurality of reinforced shelving components removably attached to the system wall.

7. The hybrid containment module of claim 6, further comprising support plates for said plurality of reinforced shelving components.

8. The hybrid containment module of claim 1 further comprising an interlocking mechanism to provide a seal to control the environment of the confined space.

9. The hybrid containment module of claim 1 further comprising prefabricated wall sections secured to the floor with a base anchor plate to fully seal the contained space.

10. The hybrid containment module of claim 1, wherein the self-supportive partition panels are selected from the group consisting of: tempered glass, fire rated glass, a factory assembled fire rated wall and clean room partitions.

11. The hybrid containment module of claim 1 configured to form a biosafety level 3 structure with insulated wall panels and insulated airtight ceiling panels and HVAC.

12. The hybrid containment module of claim 1 configured to form a clean room structure with insulated wall panels and insulated airtight ceiling panels and HVAC.

13. The hybrid containment module of claim 1 wherein said hybrid containment module is adaptable by adding or removing selective modular components to reversible achieve an open bench type structure, a biosafety level 2, a biosafety level 3 or a clean room.

14. A method of partitioning a laboratory containment biosafety space comprising:
a. providing at least two hybrid partitionable system walls having support elements;
b. providing at least one self-supportive partition panel;
c. attaching the at least one self-supportive panel to said support elements on the at least two hybrid partitionable system walls; and
d. attaching biosafety cabinets to said hybrid partitionable system walls.

15. The method of partitioning a laboratory containment biosafety space of claim 14, further comprising moving utility lines housed within at least one of the hybrid partitionable base walls.

16. The method of partitioning a laboratory containment biosafety space of claim 14, further comprising removing detachably installed shelves from at least one of the hybrid partitionable base walls prior to attaching the at least one self-supportive partition panel and reinstalling the detachably installed shelves thereafter.

17. The method of partitioning a laboratory containment biosafety space of claim 14, further comprising structural members containing grooves, wherein umbilical attachment of utilities is provided for gases, air, vacuum, water, power and data.
